(19) United States
(12) Patent Application Publication
(10) Pub. No.: US 2009/0316316 A1
(43) Pub. Date: Dec. 24, 2009

(54) ELECTRICAL CIRCUIT

(75) Inventor: Tetsuyoshi SHIOTA, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/394,694

(22) Filed: Feb. 27, 2009

(30) Foreign Application Priority Data
Jun. 23, 2008 (JP) 2008-163567

(51) Int. Cl. H02H 9/00

(52) U.S. Cl. 361/56

(57) ABSTRACT

An electrical circuit includes a first power supply line, a second power supply line, a detection circuit, a first switch device, and a nonlinear device. The detection circuit is connected to the first power supply line, and includes an output section that outputs a detection signal by detecting a change in potential of the first power supply line. The first switch device is provided between the first power supply line and the second power supply line, and is controlled by the detection signal. The nonlinear device is provided between the first or the second power supply line and the output section.

### CROSS REFERENCE TO RELATED APPLICATION

This application is based upon and claims the benefit of priority of the prior Japanese Patent Application No. 2008-163567, filed on Jun. 23, 2008, the entire contents of which are incorporated herein by reference.

### FIELD

The embodiments discussed herein are related to an electrical circuit.

### BACKGROUND

Generally, when an electrostatically charged article or human body comes close enough to an external terminal of a semiconductor product, electrostatic discharge (ESD) occurs between the article or human body and the external terminal of the semiconductor product. If a voltage greater than the breakdown voltage of the internal circuitry of the semiconductor product is applied by such ESD, the internal circuitry may be destroyed.

To prevent ESD destruction of the internal circuitry, an electrostatic discharge protection circuit (ESD protection circuit) that conducts bypass current in the event of occurrence of a voltage greater than the breakdown voltage of the internal circuitry is provided for the terminals of the semiconductor product in order to protect its internal circuit.

The ESD protection circuit must be made so as not to conduct bypass current during normal power-on operation. Such an ESD protection circuit is implemented, for example, by utilizing the fact that the rise time of the ESD voltage waveform is about 100 ns which is sufficiently shorter than the power-on rise time which is about 10 μs.

In the prior art, it is known to provide an ESD protection circuit such as a “1RC3Inv-Std” ESD protection circuit that comprises one resistor (R), one capacitor (C), and three inverters.

Further, to address the recent need to reduce the power consumption of LSI (Large Scale Integration) circuits, it is known to provide a technique in which a power supply switch is provided within an LSI circuit and is operated to isolate the supply voltage from the LSI internal circuit when the internal circuit is not in use, or a voltage regulator is provided within an LSI circuit and the internal circuit is operated by reducing the supply voltage.

In the prior art electrical circuit having such a power supply switch or voltage regulator, when the power supply switch is turned on, for example, the ESD protection circuit may operate erroneously, and the power consumption may not be able to be reduced sufficiently.

### SUMMARY

According to an aspect of the embodiments, an electrical circuit includes a first power supply line; a second power supply line; a detection circuit; a first switch device; and a nonlinear device. The detection circuit is connected to the first power supply line, and includes an output section that outputs a detection signal by detecting a change in potential of the first power supply line. The first switch device is provided between the first power supply line and the second power supply line, and is controlled by the detection signal; and the nonlinear device is provided between the first or the second power supply line and the output section.

The object and advantages of the embodiments will be realized and attained by means of the elements and combinations particularly pointed out in the appended claims.

It is to be understood that both the foregoing general description and the following detailed description are exemplary and explanatory and are not restrictive of the embodiments, as claimed.

### BRIEF DESCRIPTION OF DRAWINGS

FIG. 1 is a circuit diagram illustrating one example of an electrical circuit according to the related art;

FIG. 2 is a waveform diagram for explaining the operation of an ESD protection circuit during application of ESD in the electrical circuit of FIG. 1;

FIG. 3 is a waveform diagram for explaining the operation of the ESD protection circuit during conduction of a power supply switch in the electrical circuit of FIG. 1;

FIG. 4 is a circuit diagram illustrating one example of an electrical circuit according to a first embodiment;

FIGS. 5A and 5B are diagrams for explaining the number of diodes to be provided in an ESD protection circuit in the electrical circuit of FIG. 4;

FIG. 6 is a waveform diagram for explaining the operation of the ESD protection circuit during application of ESD in the electrical circuit of FIG. 4;

FIG. 7 is a waveform diagram for explaining the operation of the ESD protection circuit during conduction of a power supply switch in the electrical circuit of FIG. 4;

FIG. 8 is a waveform diagram for explaining the operation of the ESD protection circuit when the potential of a voltage regulator rises in the electrical circuit of FIG. 4;

FIG. 9 is a circuit diagram illustrating one example of an electrical circuit according to a second embodiment;

FIG. 10 is a waveform diagram for explaining the operation of an ESD protection circuit during application of ESD in the electrical circuit of FIG. 9;

FIG. 11 is a waveform diagram for explaining the operation of the ESD protection circuit during conduction of a power supply switch in the electrical circuit of FIG. 9;

FIG. 12 is a circuit diagram illustrating one example of an electrical circuit according to a third embodiment;

FIG. 13 is a waveform diagram for explaining the operation of an ESD protection circuit during application of ESD in the electrical circuit of FIG. 12;

FIG. 14 is a waveform diagram for explaining the operation of the ESD protection circuit during conduction of a power supply switch in the electrical circuit of FIG. 12;

FIG. 15 is a circuit diagram illustrating one example of an electrical circuit according to a fourth embodiment.

FIG. 16 is a waveform diagram for explaining the operation of an ESD protection circuit during application of ESD in the electrical circuit of FIG. 15;

FIG. 17 is a waveform diagram for explaining the operation of the ESD protection circuit during conduction of a power supply switch in the electrical circuit of FIG. 15;

FIG. 18 is a circuit diagram illustrating one example of an electrical circuit according to a fifth embodiment; and

FIG. 19 is a circuit diagram illustrating one example of an electrical circuit according to a sixth embodiment.

### DESCRIPTION OF EMBODIMENTS

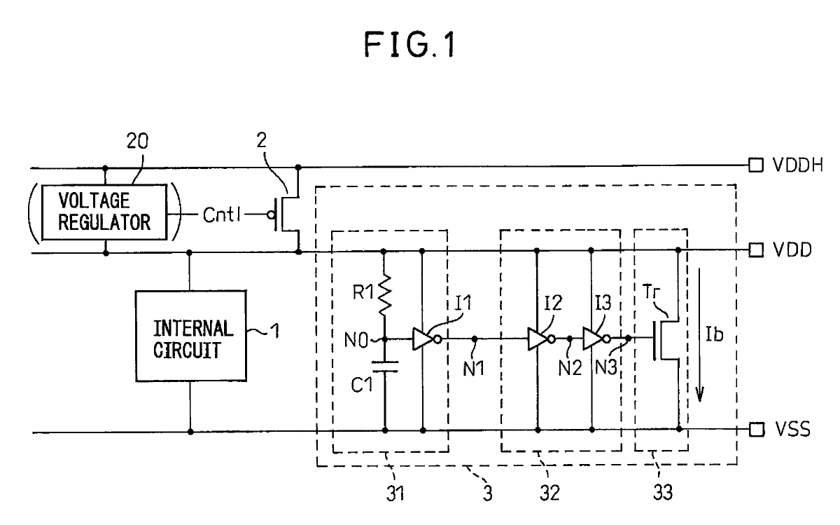

Before proceeding to the detailed description of the embodiments, an electrical circuit according to the related art will be described with reference to FIGS. 1 to 3.

FIG. 1 is a circuit diagram illustrating one example of the electrical circuit according to the related art, which comprises an internal circuit 1, a power supply switch 2 (or a voltage regulator 20), and an ESD protection circuit 3.

As illustrated in FIG. 1, the power supply switch 2 is provided within the LSI circuit and is operated to shut off the supply voltage to the internal circuit 1 when the internal circuit 1 is not in use, or the voltage regulator 20 is provided within the LSI circuit and the internal circuit 1 is operated by reducing the supply voltage. That is, the power supply switch 2 or the voltage regulator 20 is provided between the power supply lines VDDH and VDD.

Here, the portion of the VDD line after passing the power supply switch 2 or voltage regulator 20 is connected to an external terminal of the LSI circuit to monitor the potential during testing or during normal operation. There is therefore a need to provide ESD protection for the power supply terminal to which the VDD line is connected, and as a result, the ESD protection circuit 3 such as “1RC3Inv-Std” is provided.

In the electrical circuit of the related art illustrated in FIG. 1, a high supply voltage (the potential of the VDDH line) is applied externally, and by controlling this voltage on and off using the power supply switch 2 constructed from a p-channel MOS (pMOS) transistor, the supply voltage (the potential of the VDD line) is applied to the internal circuit 1. Or, instead of switching the supply voltage using the power supply switch 2 as described above, a voltage lower than the potential of the VDDH line may be generated using, for example, the voltage regulator 20, for application to the internal circuit 1.

As illustrated in FIG. 1, the ESD protection circuit 3 comprises a rise time detection circuit 31 for detecting the rise time of the potential of the VDD line, a pre-driver 32, and a power supply clamp 33.

The rise time detection circuit 31 comprises a resistor R1 and a capacitor C1 connected in series between the power supply line (VDD line) and ground line (VSS line), and an inverter I1 whose input is coupled to a node N0 connecting between R1 and C1 and whose output provides a detection signal.

The pre-driver 32 comprises two stages of inverters I2 and I3 whose input is coupled to an output node N1 of the inverter I1, and the power supply clamp 33 is constructed from an n-channel MOS (nMOS) transistor Tr whose drain and source are connected to the VDD line and VSS line, respectively, and whose gate is connected to an output node N3 of the inverter I3.

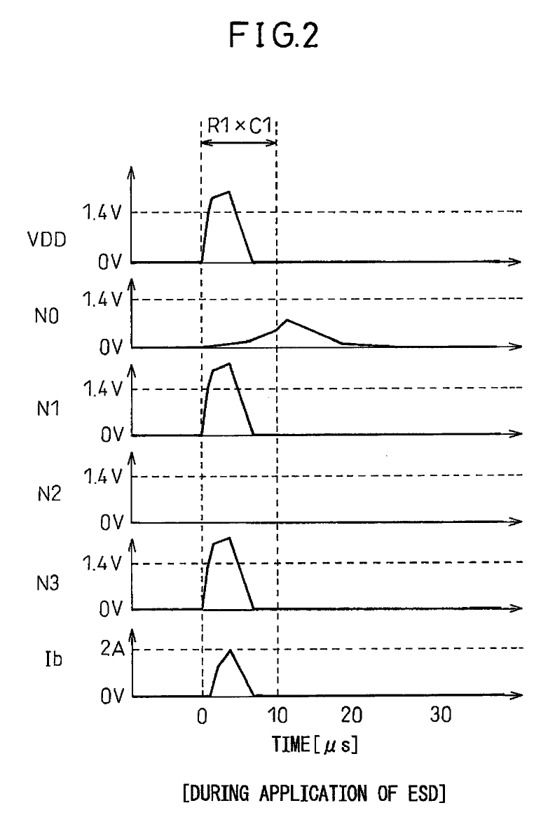

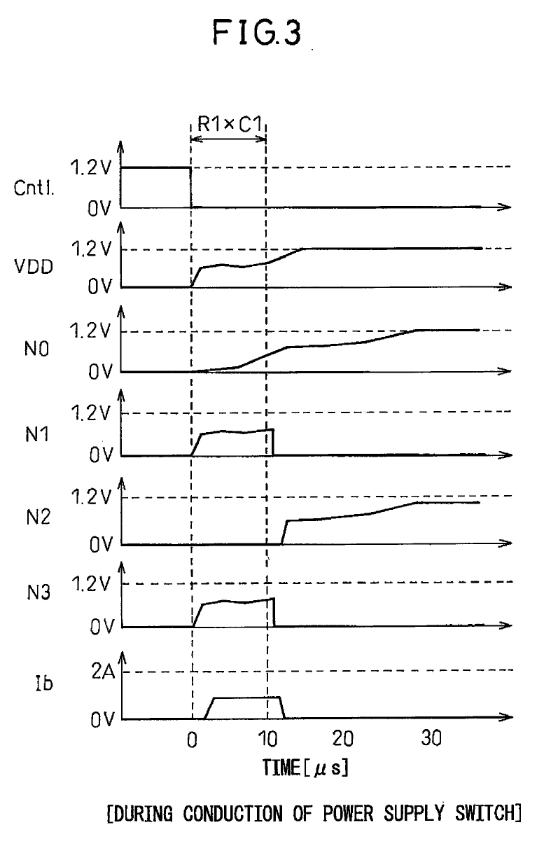

FIG. 2 is a waveform diagram for explaining the operation of the ESD protection circuit during application of ESD in the electrical circuit of FIG. 1, and FIG. 3 is a waveform diagram for explaining the operation of the ESD protection circuit during conduction of the power supply switch in the electrical circuit of FIG. 1.

As illustrated in FIGS. 2 and 3, the output (N0) of the rise time detection circuit 31 is held at the potential level of the VSS line when the potential of the VDD line is constant. However, when the potential of the VDD line increases with a rise time sufficiently shorter than the time constant (R1×C1) of the resistor R1 and capacitor C1, a spike occurs on the output (N0) of the rise time detection circuit 31.

On the other hand, when the rise time is sufficiently longer than the time constant (R1×C1) of R1 and C1, no spike occurs and the output of the rise time detection circuit 31 remains at the potential level of the VSS line. In view of this, the time constant of R1 and C1 is made sufficiently longer than the rise time of the spike waveform associated with ESD but sufficiently shorter than the rise time of the power-on waveform so that the rise time detection circuit 31 outputs a spike in the event of an ESD spike but does not output a spike during power on.

With this arrangement, the power supply clamp circuit 33 after the pre-driver 32 is turned on to conduct bypass current only during application of ESD.

That is, as illustrated in FIG. 2, when an ESD spike is applied to an external terminal of the VDD line, current (Ib) flows through the power supply clamp circuit 33, but when the potential of the VDD line is constant, the transistor Tr in the power supply clamp circuit 33 remains off.

However, as illustrated in FIG. 3, when the potential of the VDD line is at the potential level of the VSS line, if the power supply switch 2 is turned on, the potential of the VDD line rises to nearly the same level as the potential of the VDDH line; here, since the rise time is, for example, about 100 ns, the power supply clamp 33 turns on to conduct the bypass current (Ib). The potential rise of the voltage regulator 20 can be explained in the same manner as the conduction of the power supply switch 2.

In this way, in the electrical circuit of the related art illustrated in FIG. 1, when the ESD protection circuit 3 is provided on the portion of the VDD line after passing the power supply switch 2 or voltage regulator 20 provided within the LSI circuit, there arises the possibility that, during the conduction of the power supply switch 2 or during the potential rise of the regulator, the power supply clamp 33 may turn on to conduct current, causing power supply noise which can lead to erroneous operation of the internal circuit 1.

Accordingly, a period (for example, 10 μs or longer) sufficiently longer than the rise time of the ESD spike must be allowed for the conduction of the power supply switch 2 or the potential rise of the voltage regulator 20, and since the circuit operation has to be stopped during this period, processing performance drops. On the other hand, in the case of an electrical circuit that requires sufficient processing performance, the power supply switch 2 cannot be turned off, or the voltage cannot be changed by the voltage regulator 20, and the power consumption cannot be reduced as intended.

In view of the above problem, the present application aims to provide an electrical circuit that can increase processing speed and reduce power consumption while providing reliable ESD protection.

Embodiments of such an electrical circuit will be described below with reference to the accompanying drawings.

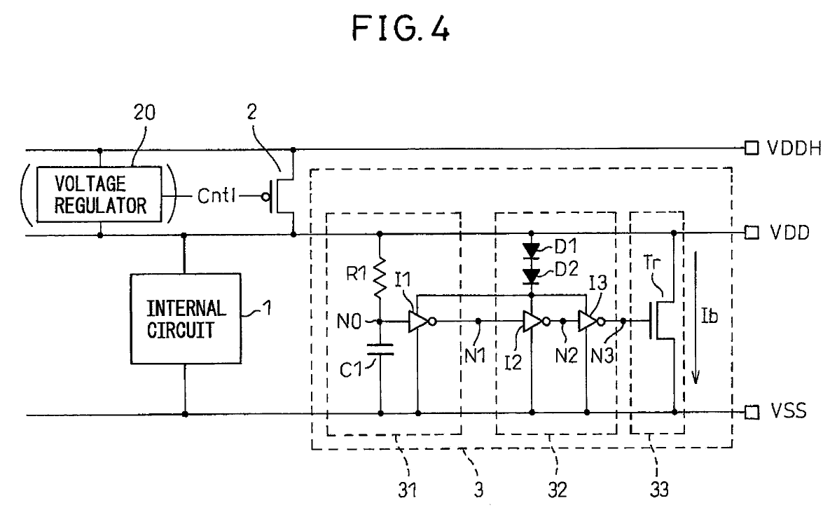

FIG. 4 is a circuit diagram illustrating one example of an electrical circuit according to a first embodiment, which comprises an internal circuit 1, a power supply switch 2 (or a voltage regulator 20), and an ESD protection circuit 3.

As is apparent from a comparison between FIG. 4 and the previously given FIG. 1, the electrical circuit of the first embodiment differs from the electrical circuit of the related art illustrated in FIG. 1 by the inclusion of a diode, for example, two stages of diodes D1 and D2, between the VDD line (first power supply line) and the array of inverters I1 to I3. A diode is a device classified as a nonlinear device that exhibits a nonlinear current-voltage characteristic.

As illustrated in FIG. 4, in the first embodiment, the power supply switch 2 is provided within the LSI circuit and is operated to shut off the supply voltage to the internal circuit 1 when the internal circuit 1 is not in use, or the voltage regulator 20 is provided within the LSI circuit and the internal circuit 1 is operated by reducing the supply voltage. That is, the power supply switch 2 or the voltage regulator 20 is provided between the VDDH line (third power supply line) and the VDD line.

Here, the portion of the VDD line after passing the power supply switch 2 or voltage regulator 20 is connected to an external terminal of the LSI circuit to monitor the potential during testing or during normal operation, and the ESD protection circuit 3 is also provided for the power supply terminal of the VDD line.

In the electrical circuit of the first embodiment illustrated in FIG. 4, a high supply voltage is applied externally to the VDDH line, and by controlling this voltage on and off using the power supply switch 2 constructed from a pMOS transistor, the supply voltage (the potential of the VDD line) is applied to the internal circuit 1. Or, instead of switching the supply voltage using the power supply switch 2 as described above, a voltage lower than the potential of the VDDH line may be generated using, for example, the voltage regulator 20, for application to the internal circuit 1.

As illustrated in FIG. 4, the ESD protection circuit 3 comprises a rise time detection circuit 31 for detecting the rise time of the supply voltage (the potential of the VDD line), a pre-driver 32, and a power supply clamp 33.

The rise time detection circuit 31 comprises a resistor R1 and a capacitor C1 connected in series between the power supply line (VDD line: first power supply line) and ground line (VSS line: second power supply line), and an inverter, for example, a CMOS buffer I1, whose input is coupled to a node N0 connecting between R1 and C1 and whose output provides a detection signal.

The pre-driver 32 comprises two stages of inverters I2 and I3 whose input is coupled to an output node N1 of the inverter I1, and two stages of diodes D1 and D2 connected in series, and the power supply clamp 33 is constructed from an nMOS transistor Tr whose drain and source are connected to the VDD line and VSS line, respectively, and whose gate is connected to an output node N3 of the inverter I3.

As is apparent from FIG. 4, in the electrical circuit of the first embodiment, diodes as nonlinear devices, in the illustrated example, the two stages of diodes D1 and D2 connected in series, are inserted in a forward direction to control the voltage applied to the inverters I1 to I3.

In the case of a diode formed from a pn junction of a silicon semiconductor, the potential difference (the threshold value: Vth) at which a forward current beings to flow is about 0.7 V. Accordingly, when the supply voltage (the potential of the VDD line) is, for example, 1.2 V, if two diodes are inserted in series, a voltage drop of 1.4 V or greater is produced across the diodes, which means that, for a voltage rise smaller than that, the inverters I1 to I3 can be prevented from operating.

In this way, the number, n, of diodes to be inserted in series can be easily obtained by determining it so as to satisfy the condition that Vth×n is not smaller than the supply voltage (the potential of the VDD line) but smaller than the breakdown voltage Vb of the internal circuit.

Further, the number may be determined so as to satisfy the condition Vb>Vth×n>VDD−Vmin−inv by considering the minimum supply voltage (Vmin−inv) at which the inverters I1 to I3 operate.

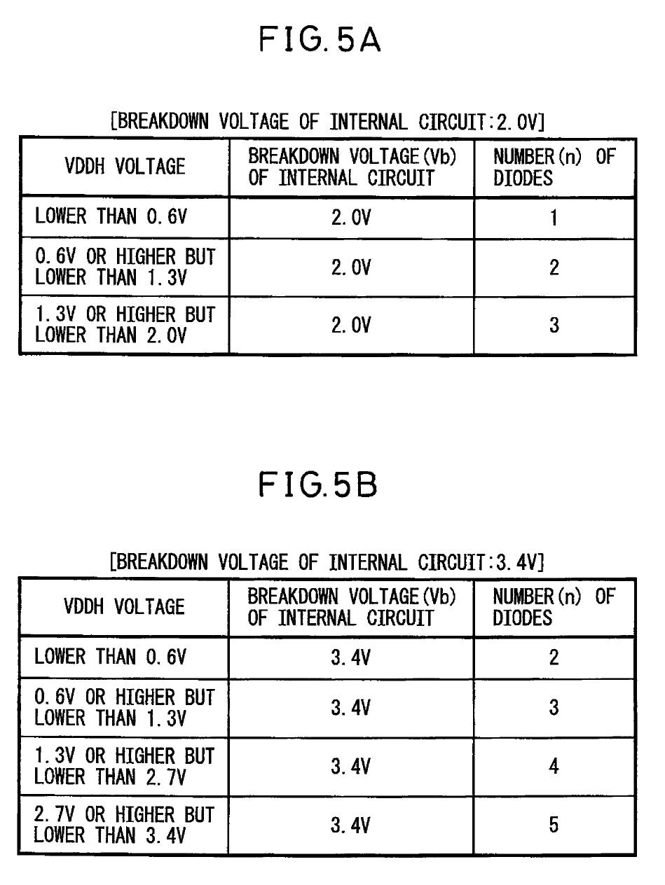

FIGS. 5A and 5B are diagrams for explaining the number of diodes to be provided in the ESD protection circuit in the electrical circuit of FIG. 4: FIG. 5A illustrates the case when the breakdown voltage of the internal circuit 1 is 2.0 V, and FIG. 5B illustrates the case when the breakdown voltage of the internal circuit 1 is 3.4 V.

That is, as illustrated in FIGS. 5A and 5B, the relationship between the supply voltage (for example, the potential of the VDDH line) and the number, n, of diodes is determined in advance for the breakdown voltage Vb of the internal circuit 1, and the number of diodes to be inserted may be determined in accordance with the thus determined relationship. The table used for this purpose can be constructed by performing simulation or by actually making measurements.

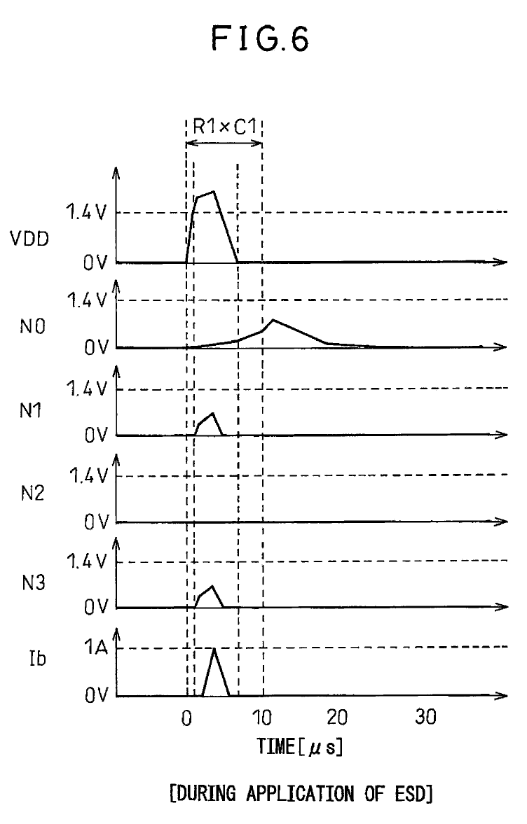

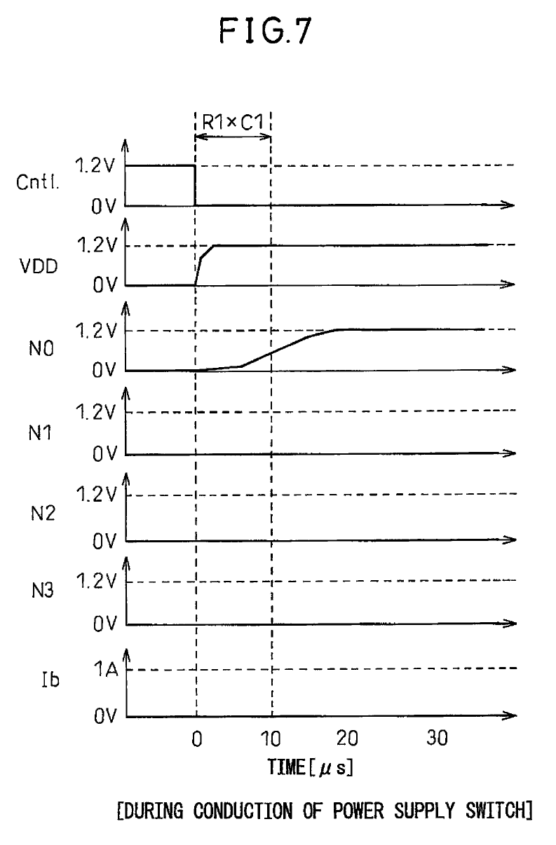

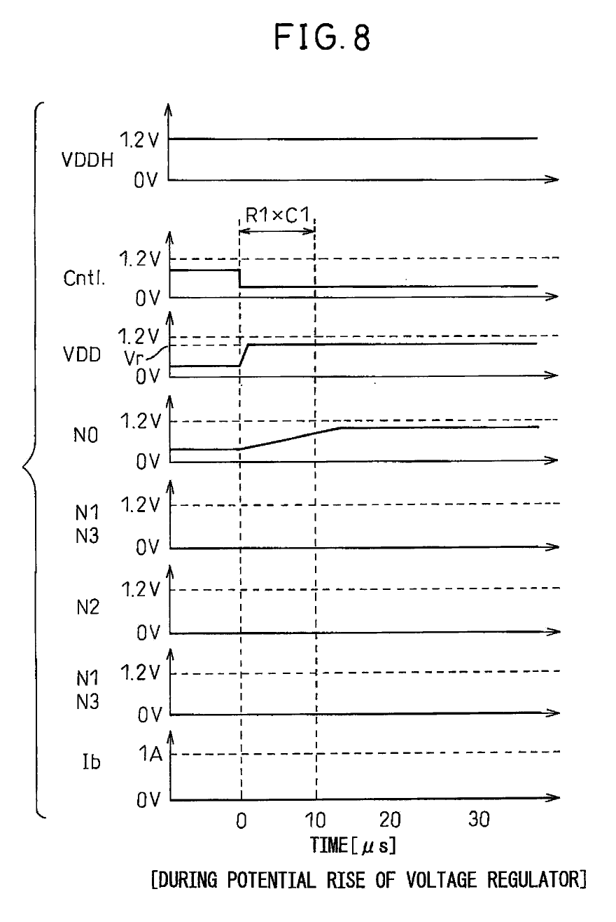

FIG. 6 is a waveform diagram for explaining the operation of the ESD protection circuit during application of ESD in the electrical circuit of FIG. 4, FIG. 7 is a waveform diagram for explaining the operation of the ESD protection circuit during conduction of the power supply switch in the electrical circuit of FIG. 4, and FIG. 8 is a waveform diagram for explaining the operation of the ESD protection circuit when the potential of the voltage regulator rises in the electrical circuit of FIG. 4.

First, as illustrated in FIG. 6, during application of ESD, an ESD spike is applied, and the current flows into the ESD protection circuit 3, causing the potential of the VDD line to rapidly rise. The rise rate is about 1 V per 100 ns.

At this time, the internal node N0 of the ESD protection circuit 3 rises with a delay determined by the time constant R1×C1. When the time constant R1×C1 is 10 μs, the node N1 remains at substantially zero even at the time that the potential of the VDD line reaches 1.4 V.

Then, when the potential of the VDD line exceeds 1.4 V, the three inverters I1 to I3 operate, and the power supply clamp 33 turns on. As a result, the transistor Tr conducts, allowing the ESD current to flow as the bypass current Ib, preventing the potential from further rising, and thus protecting the internal circuit 1.

Next, as illustrated in FIG. 7, when the power supply switch 2 conducts, that is, when the control signal Cnt1 changes from high level (1.2 V) to low level (0 V), and the power supply switch 2 turns on, the current flows from the VDDH line into the VDD line. It is assumed here that when the power supply switch 2 turns on, the potential of the VDD line is at 0 V.

Then, immediately after the power supply switch 2 turns on, the current flows into the VDD line, causing its potential to rise. The rise rate is about 1 V per 100 ns. This rise rate is the same as that during the ESD application.

However, as illustrated in FIG. 7, when the potential of the VDD line reaches 1.2 V, the potential stops rising and remains constant. Here, because of the presence of the diodes D1 and D2, when the potential of the VDD line is 1.4 V or lower, the inverters I1 to I3 do not operate, and the power supply clamp 33 does not turn on.

Further, as illustrated in FIG. 8, when the potential of the voltage regulator 20 rises, the potential of the VDD line also rises but, when it reaches the output voltage Vr of the voltage regulator 20, the potential stops rising and remains constant. Here, because of the presence of the diodes D1 and D2, when the potential of the VDD line is 1.4 V or lower, the inverters I1 to I3 do not operate, and the power supply clamp 33 does not turn on.

In the electrical circuit of the first embodiment illustrated in FIG. 4, the inverter array has been illustrated as being constructed from three stages I1 to I3, but it will be appreciated that a similar effect can be obtained as long as the inverter array is constructed from an odd number of inverter stages, and that a similar effect can also be achieved with an even number of inverter stages if the power supply clamp 33 is constructed from a pMOS transistor.

As described above, according to the electrical circuit of the first embodiment, even when the supply voltage changes under normal operating conditions of the electrical circuit, as when the switch conducts or when the potential of the voltage regulator rises, the power supply clamp 33 can be held in the off state even if the rise time is short. This prevents the occurrence of power supply noise and thereby prevents the erroneous operation of the internal circuit 1. Furthermore, since the supply voltage can be caused to rise quickly when the switch conducts or when the potential of the voltage regulator rises, the processing speed can be increased while reducing the power consumption.

The effect achieved with the electrical circuit of the first embodiment can also be achieved with the electrical circuits of the second to sixth embodiments hereinafter described. Further, it will be appreciated that in the second to sixth embodiments also, the voltage regulator 20 can be provided instead of the power supply switch 2.

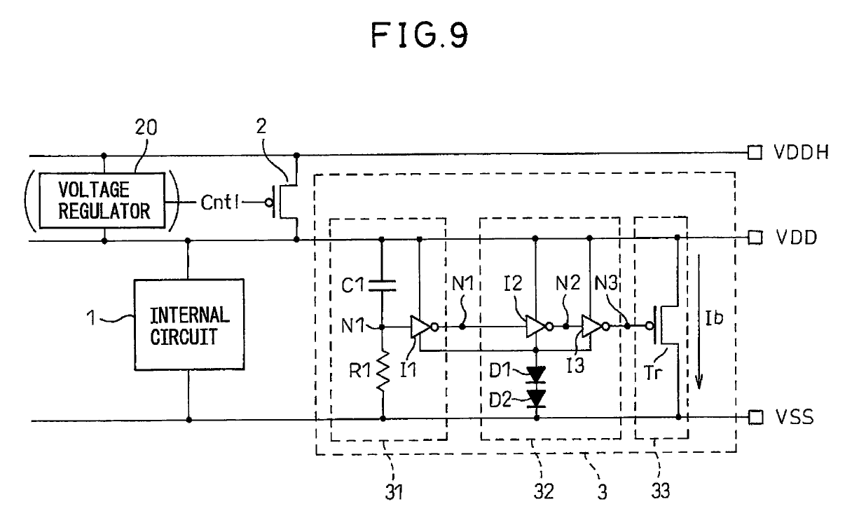

FIG. 9 is a circuit diagram illustrating one example of the electrical circuit according to the second embodiment.

As is apparent from a comparison with the first embodiment illustrated in FIG. 4, the electrical circuit of the second embodiment illustrated in FIG. 9 differs in that the diodes as nonlinear resistive elements, in the illustrated example, the two stages of diodes D1 and D2 connected in series, are inserted in a forward direction between the ground line (VSS line: second power supply line) and the array of inverters I1 to I3, to control the voltage applied to the inverters I1 to I3. Further, the power supply clamp 33 is constructed from a pMOS transistor.

Furthermore, in the electrical circuit of the second embodiment, the bypass filter is constructed by reversing the arrangement of the capacitor C1 and resistor R1 in the rise time detection circuit 31 from that illustrated in the first embodiment.

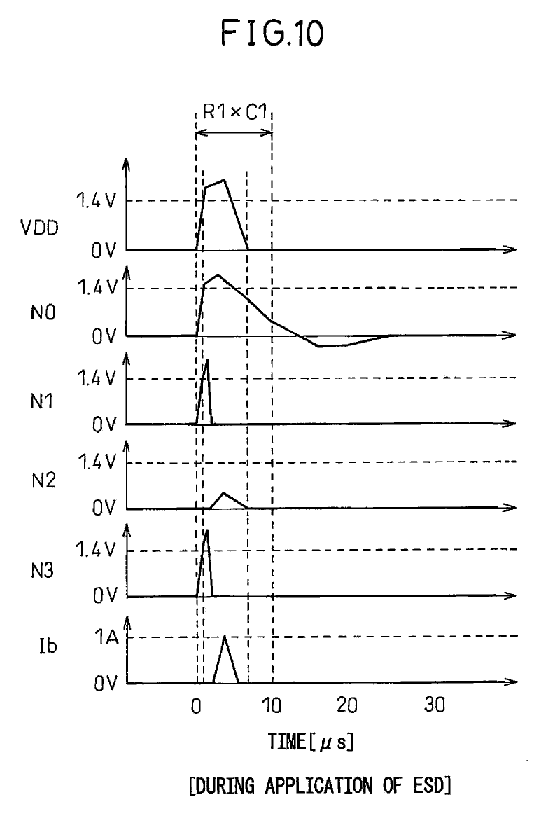

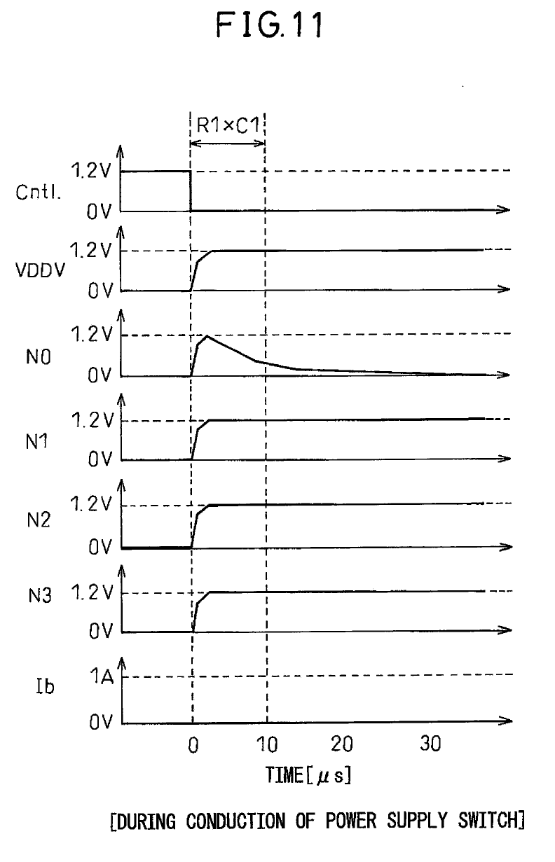

FIG. 10 is a waveform diagram for explaining the operation of the ESD protection circuit during application of ESD in the electrical circuit of FIG. 9, and FIG. 11 is a waveform diagram for explaining the operation of the ESD protection circuit during conduction of the power supply switch in the electrical circuit of FIG. 9.

First, as illustrated in FIG. 10, during application of ESD, an ESD spike is applied, and the current flows into the ESD protection circuit 3, causing the potential of the VDD line to rapidly rise, and when the potential of the VDD line exceeds 1.4 V, the three inverters I1 to I3 operate, and the power supply clamp 33 turns on. As a result, the transistor Tr conducts, allowing the ESD current to flow as the bypass current Ib, preventing the potential from further rising, and thus protecting the internal circuit 1.

Next, as illustrated in FIG. 11, when the power supply switch 2 conducts, the current flows immediately after the turning on of the power supply switch 2, and the potential of the VDD line rises, but when the potential of the VDD line reaches 1.2 V, the potential stops rising and remains constant. Here, because of the presence of the diodes D1 and D2, when the potential of the VDD line is 1.4 V or lower, the inverters I1 to I3 do not operate, and since the output nodes N1 to N3 of the inverters I1 to I3 remain high (1.2 V), the power supply clamp 33 does not turn on.

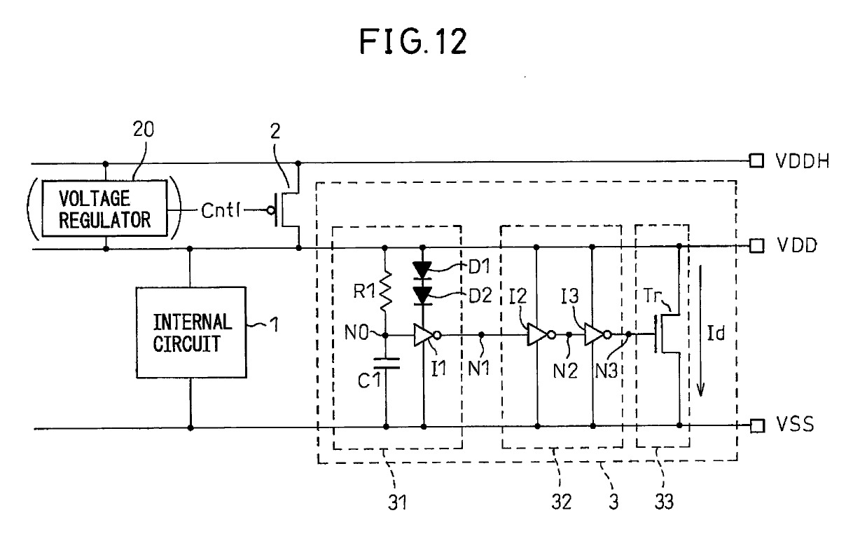

FIG. 12 is a circuit diagram illustrating one example of the electrical circuit according to the third embodiment.

As is apparent from a comparison with the first embodiment illustrated in FIG. 4, the electrical circuit of the third embodiment illustrated in FIG. 12 differs in that the two stages of diodes D1 and D2 connected in series are inserted in a forward direction, only between the power supply line (VDD line: first power supply line) and the inverter I1 in the rise time detection circuit 31, to control the voltage applied to the inverter I1. That is, no diodes are inserted between the VDD line and the inverters I2 and I3 in the pre-driver 32.

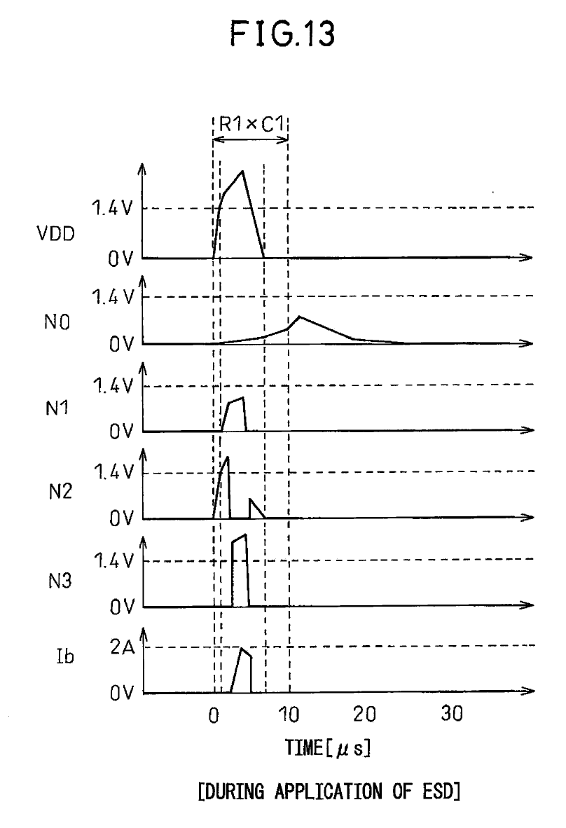

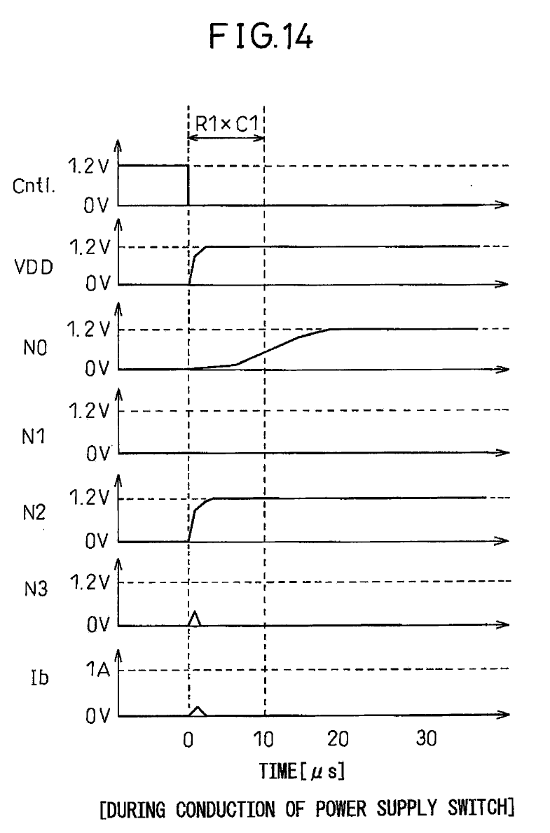

FIG. 13 is a waveform diagram for explaining the operation of the ESD protection circuit during application of ESD in the electrical circuit of FIG. 12, and FIG. 14 is a waveform diagram for explaining the operation of the ESD protection circuit during conduction of the power supply switch in the electrical circuit of FIG. 12.

First, as illustrated in FIG. 13, during application of ESD, an ESD spike is applied, and the current flows into the ESD protection circuit 3, causing the potential of the VDD line to rapidly rise, and when the potential of the VDD line exceeds 1.4 V, the three inverters I1 to 13 operate, and the power supply clamp 33 turns on. As a result, the transistor Tr conducts allowing the ESD current to flow as the bypass current Ib, preventing the potential from further rising, and thus protecting the internal circuit 1.

Next, as illustrated in FIG. 14, when the power supply switch 2 conducts, the current flows immediately after the turning on of the power supply switch 2, and the potential of the VDD line rises, but when the potential of the VDD line reaches 1.2 V, the potential stops rising and remains constant. Here, because of the presence of the diodes D1 and D2, when the potential of the VDD line is 1.4 V or lower, the inverter I1 does not operate, and since the output nodes N1 and N3 remain at nearly 0 V, the transistor Tr does not turn on.

In this way, in the electrical circuit of the third embodiment, since the gate potential of the power supply clamp that turns on during application of ESD is held at the potential level of the VDD line, the bypass current Ib can be increased. On the other hand, when the power supply switch 2 conducts, the bypass current Ib flows momentarily because the level of the node N3 is raised, but the power supply is designed so that the power supply noise caused by this current does not affect the internal circuit. In this case, since the current that flows through the inverter I1 is small, the diodes D1 and D2 can be constructed from devices having low breakdown voltage, and the electrical circuit can therefore be implemented in a smaller area than the electrical circuit of the first embodiment.

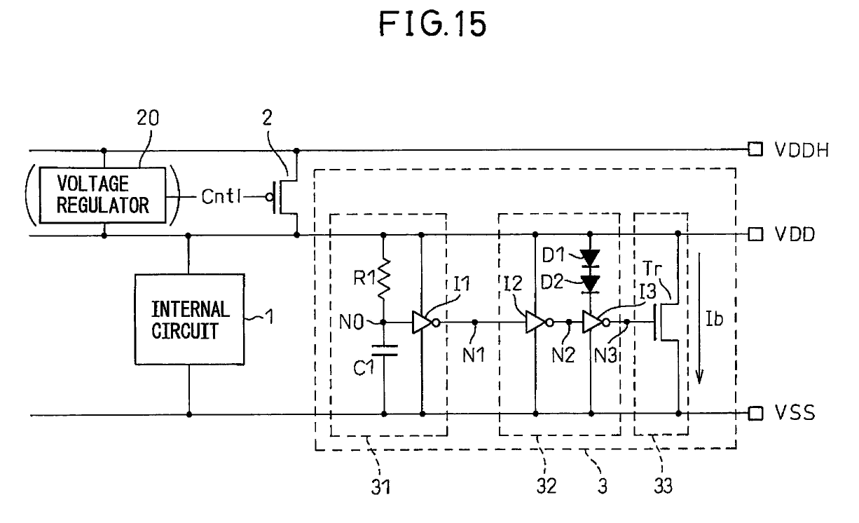

FIG. 15 is a circuit diagram illustrating one example of the electrical circuit according to the fourth embodiment.

As is apparent from a comparison with the first embodiment illustrated in FIG. 4, the electrical circuit of the fourth embodiment illustrated in FIG. 15 differs in that the two stages of diodes D1 and D2 connected in series are inserted in a forward direction, only between the power supply line (VDD line: first power supply line) and the inverter I3 in the last stage of the pre-driver 32, to control the voltage applied to the inverter I3. That is, no diodes are inserted between the VDD line and the inverter I1 in the rise time detection circuit 31 or the inverter I2 in the first stage of the pre-driver 32.

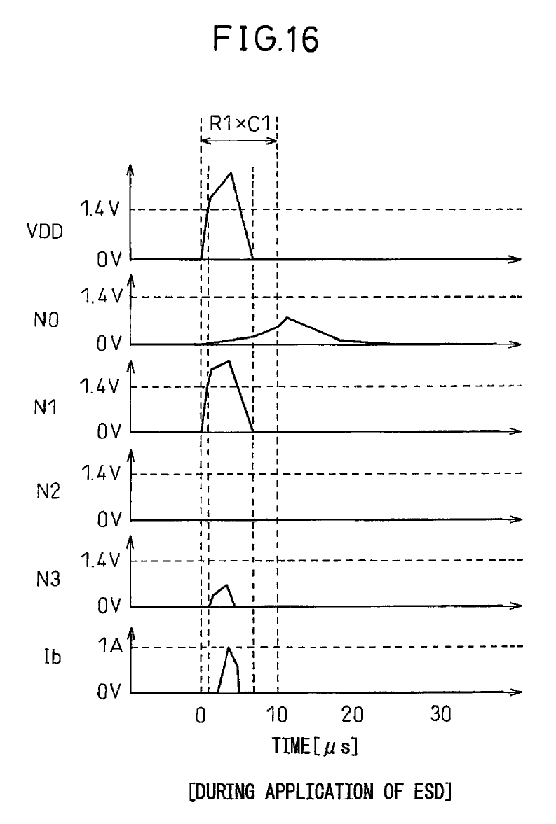

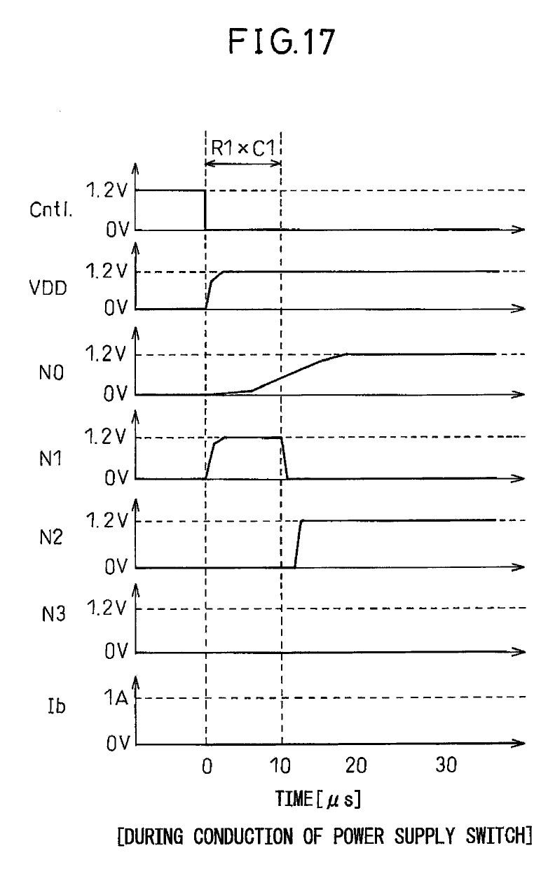

FIG. 16 is a waveform diagram for explaining the operation of the ESD protection circuit during application of ESD in the electrical circuit of FIG. 15, and FIG. 17 is a waveform diagram for explaining the operation of the ESD protection circuit during conduction of the power supply switch in the electrical circuit of FIG. 15.

First, as illustrated in FIG. 16, during application of ESD, an ESD spike is applied, and the current flows into the ESD protection circuit 3, causing the potential of the VDD line to rapidly rise, and when the potential of the VDD line exceeds 1.4 V, the three inverters I1 to I3 operate, and the power supply clamp 33 turns on. As a result, the transistor Tr conducts, allowing the ESD current to flow as the bypass current Ib, preventing the potential from further rising, and thus protecting the internal circuit 1.

Next, as illustrated in FIG. 17, when the power supply switch 2 conducts, the current flows immediately after the turning on of the power supply switch 2, and the potential of the VDD line rises, but when the potential of the VDD line reaches 1.2 V, the potential stops rising and remains constant. Here, because of the presence of the diodes D1 and D2, when the potential of the VDD line is 1.4 V or lower, the inverter I3 does not operate, and since the node N3 remains at 0 V, the transistor Tr does not turn on.

Here, if power supply noise fluctuating in a time shorter than the time constant of the resistor R1 and capacitor C1 is introduced into the VDD line, a shoot-through current may flow into the inverter I1 in the rise time detection circuit 31. The electrical circuit of the fourth embodiment can be applied to the case where the current flowing into the inverter I1 can be made so as not to affect other circuits.

Further, the electrical circuit of the fourth embodiment can be implemented in a smaller area than the electrical circuit of the first embodiment.

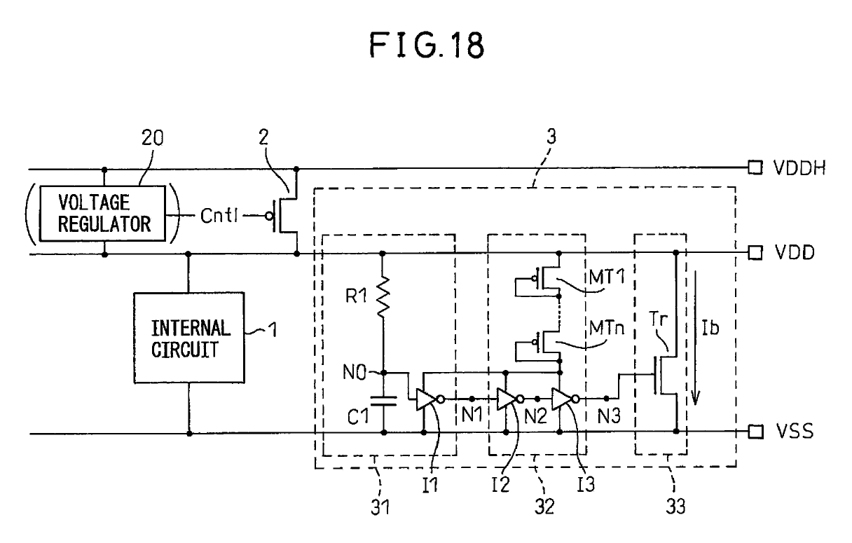

FIG. 18 is a circuit diagram illustrating one example of the electrical circuit according to the fifth embodiment.

As is apparent from a comparison with the first embodiment illustrated in FIG. 4, the electrical circuit of the fifth embodiment illustrated in FIG. 18 differs by the inclusion of n stages of diode-connected (gate connected to source) pMOS transistors MT1 to MTn instead of the two stages of diodes D1 and D2 inserted between the VDD line and the array of inverters I1 to I3.

That is, since the source-drain current-voltage characteristic of a PMOS transistor whose gate and drain are connected together is similar to that of a diode, this embodiment makes use of the characteristic that the current increases when the source-drain voltage exceeds the threshold value Vth of the transistor.

Accordingly, as in the case of the diodes D1 and D2, the number, n, of pMOS transistors to be inserted in series can be determined so as to satisfy the condition that Vth x n is not smaller than the supply voltage (the potential of the VDD line) but smaller than the breakdown voltage (Vb) of the internal circuit 1. It is apparent that the same effect can be obtained if nMOS transistors are used instead of the pMOS transistors.

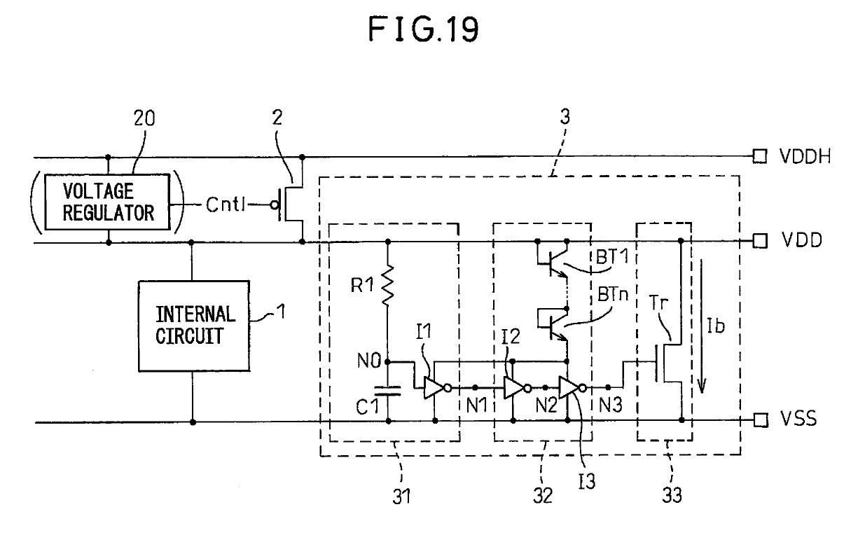

FIG. 19 is a circuit diagram illustrating one example of the electrical circuit according to the sixth embodiment.

As is apparent from a comparison with the fifth embodiment illustrated in FIG. 18 above, the electrical circuit of the sixth embodiment illustrated in FIG. 19 differs by the inclusion of n stages of base-emitter connected npn bipolar transistors BT1 to BTn instead of the n stages of diode-connected pMOS transistors MT1 to MTn.

That is, since the collector-emitter current-voltage characteristic of an npn bipolar transistor whose base and emitter are connected together is similar to that of a diode, this embodiment makes use of the characteristic that the current increases when the collector-emitter voltage exceeds the threshold voltage (Vth) of the pn junction.

Accordingly, as in the case of the diode-connected pMOS transistors MT1 to MTn or the diodes D1 and D2, the number, n, of npn bipolar transistors to be inserted in series can be determined so as to satisfy the condition that vth×n is not smaller than the supply voltage (the potential of the VDD line) but smaller than the breakdown voltage (vb) of the internal circuit 1. It is apparent that the same effect can be obtained if pnp bipolar transistors are used instead of the npn bipolar transistors.

In this way, according to the embodiments, it is possible to provide an electrical circuit that can increase processing speed and reduce power consumption while providing reliable ESD protection.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention.

Although the embodiments of the present invention have been described in detail, it should be understood that the various changes, substitutions, and alterations could be made hereto without departing from the spirit and scope of the invention.

What is claimed is:

1. An electrical circuit comprising:
a first power supply line;
a second power supply line;
a detection circuit connected to said first power supply line, and including an output section that outputs a detection signal by detecting a change in potential of said first power supply line;
a first switch device provided between said first power supply line and said second power supply line, and controlled by said detection signal; and
a nonlinear device provided between said first or said second power supply line and said output section.

2. An electrical circuit as claimed in claim 1, further comprising:
a third power supply line; and
a second switch provided between said first power supply line and said third power supply line.

3. An electrical circuit as claimed in claim 1, further comprising:
a third power supply line; and
voltage changing means provided between said first power supply line and said third power supply line.

4. An electrical circuit as claimed in claim 1, further comprising:
an internal circuit to which power is supplied from said first power supply line.

5. An electrical circuit as claimed in claim 1, further comprising:
an external terminal connected to said first power supply line.

6. An electrical circuit as claimed in claim 1, further comprising:
a driver circuit provided between said detection circuit and said first switch.

7. An electrical circuit as claimed in claim 6, wherein said driver circuit is connected to said first power supply line or said second power supply line via said nonlinear device.

8. An electrical circuit as claimed in claim 1, wherein said nonlinear device includes either a diode including a PN junction or a diode-connected MOS transistor or a diode-connected bipolar transistor.

9. An electrical circuit as claimed in claim 1, wherein said detection circuit includes a resistive element and a capacitive element provided between said first power supply line and said second power supply line.

10. An electrical circuit as claimed in claim 9, wherein said output section is a CMOS buffer, whose input is coupled to a node connecting between said resistive element and said capacitive element.

11. An electrical circuit as claimed in claim 1, wherein said driver circuit is a CMOS buffer, and a transistor forming said driver circuit includes a greater driving capability than a transistor forming said output section.

12. An electrical circuit as claimed in claim 11, wherein
the CMOS buffer forming said output section is constructed from an inverter,
the CMOS buffer forming said driver circuit is constructed from a plurality of stages of inverters, and
said plurality of stages of inverters forming said driver circuit are connected to said first power supply line or said second power supply line via said nonlinear device to which said inverter forming said output section is also connected.

13. An electrical circuit comprising:
a first power supply line;
a second power supply line;
a detection circuit, connected to said first power supply line, detecting a change in potential of said first power supply line;
a first switch device provided between said first power supply line and said second power supply line;
a driver circuit provided between said detection circuit and said first switch device; and
a nonlinear device provided between said first or said second power supply line and said driver circuit.

14. An electrical circuit as claimed in claim 13, further comprising:
a third power supply line; and
a second switch provided between said first power supply line and said third power supply line.

15. An electrical circuit as claimed in claim 13, further comprising:
a third power supply line; and
voltage changing means provided between said first power supply line and said third power supply line.

16. An electrical circuit as claimed in claim 13, further comprising:
an internal circuit to which power is supplied from said first power supply line.

17. An electrical circuit as claimed in claim 13, further comprising:
an external terminal connected to said first power supply line.

18. An electrical circuit as claimed in claim 13, wherein said nonlinear device includes either a diode including a PN junction or a diode-connected MOS transistor or a diode-connected bipolar transistor.

19. An electrical circuit as claimed in claim 13, wherein said detection circuit includes a resistive element and a capacitive element provided between said first power supply line and said second power supply line, and an output section that is coupled to a node connecting between said resistive element and said capacitive element and that outputs a detection signal by detecting a change in potential of said first power supply line.

20. An electrical circuit as claimed in claim 13, wherein said driver circuit includes a plurality of stages of inverters, and said nonlinear device is connected only to a last stage of said plurality of stages of inverters.
